(19) United States
(12) Patent Application Publication
(10) Pub. No.: US 2006/0119940 A1
(43) Pub. Date: Jun. 8, 2006

(54) Prism sheet and a backlight module adopting the same

(75) Inventor: Tai-Cherng Yu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/283,467

(22) Filed: Nov. 18, 2005

(30) Foreign Application Priority Data
Dec. 3, 2004 (TW) 93137382

(51) Int. Cl. G02B 27/44

(52) U.S. Cl. 359/565

(57) ABSTRACT

A prism sheet (42) includes a lower surface (422), an upper surface (424) opposite to the lower surface, and a refractive-diffractive hybrid lens array (426) formed on the upper surface. The refractive-diffractive hybrid lens array has a plurality of refractive-diffractive hybrid lenses (428). The refractive-diffractive hybrid lenses can reduce or even avoid chromatic aberration along axes thereof. This can converge light beams, thereby enhancing uniformity of the light beams. Thus, the prism sheet can provide satisfactory display quality. Furthermore, the refractive-diffractive hybrid lens array and the body of the prism sheet are in-mold by means of injection molding. This ensures relatively little process in the production line. Therefore, the prism sheet can be advantageously applied in backlight modules (5) of liquid crystal display devices.

### RELATED APPLICATION

This application is related to commonly-assigned applications entitled, “LIGHT GUIDE PLATE AND BACKLIGHT MODULE ADOPTING THE SAME”, filed ***** (Atty. Docket No. US**5974).

### BACKGROUND

1. Field of the Invention

The invention relates generally to prism sheets and backlight modules adopting the same and, more particularly, to a prism sheet used in liquid crystal display devices and a backlight module adopting the same.

2. Discussion of Related Art

Liquid crystal display devices have many excellent performance characteristics, such as large-scale information display ability, easy to color, low power consumption, long life, no pollution associated therewith, and so on. Therefore, liquid crystal display devices are used widely. A typical liquid crystal display device generally includes a backlight module, and the backlight module is used to convert linear light sources, such as cold cathode ray tubes, or point light sources, such as light emitting diodes, into area light sources having high uniformity and brightness.

Referring to FIG. 4, a conventional backlight module 1 includes a light guide plate 14, a reflector 12, a light source 20, a reflective cover 22, a diffusion plate 16, and a prism sheet 18. The light guide plate 14 includes an incidence surface 142, an emission surface 146, and a bottom surface 144. The emission surface 146 intersects with the incidence surface 142. The bottom surface 144 intersects with the incidence surface 142 and is opposite to the emission surface 146. The light source 20 is covered by the reflective cover 22 and is positioned beside the incidence surface 142 of the light guide plate 14. The reflector 12 is located below the bottom surface 144 of the light guide plate 14. The diffusion plate 16 is placed upon the emission surface 146 of the light guide plate 14. The prism sheet 18 is situated upon the diffusion plate 16.

The prism sheet 18 includes a body 182 and a refractive lens layer 184. The refractive lens layer 184 is molded and is attached on the body 182 before solidifying. The refractive lens layer 184 includes a plurality of refractive lenses 188. Each refractive lens 188 is a semi-spherical dot.

In use, incident light beams are emitted from the light source 20 and are transmitted into the light guide plate 14 via the incidence surface 142. The light guide plate 14 is used to direct travel of the incident light beams therein and ensure that most of the incident light beams can be emitted from the emission surface 146 thereof. The reflector 12 is used to reflect at least some and, preferably, nearly all of the incident light beams that are emitted from the bottom surface 144 of the light guide plate 14 back into the light guide plate 14. This reflection enhances the utilization ratio of the incident light beams. The diffusion plate 16 and the prism sheet 18 are used to improve uniformity of the emitted light beams.

However, lights with relatively long wavelengths have relatively small refraction angles and are focused at relatively far points when they travel through the refractive lenses 188, while lights with relatively short wavelengths have relatively big refraction angles and are focused at relatively near points when they travel through the refractive lenses 188. That is to say, the focus of each blue light, the focus of each green light and the focus of each red light are, in turn, located at successive points along on an axis of the corresponding refractive lens 188. Therefore, the emitted light beams can't be converged via the refractive lenses 188. This lack of convergence causes chromatic aberration, and, as such, the conventional backlight module 1 can't provide satisfactory uniformity of the emitted light beams. Furthermore, the body 182 and the refractive lens layer 184 of the prism sheet 18 are formed as two separate parts and are then attached together. This results in more process steps in the production line, thereby increasing the manufacturing cost of the prism sheet.

What is needed, therefore, is a prism sheet which is easy to make and which can reduce or even avoid chromatic aberration of light beams.

What is also needed is a backlight module adopting the above-mentioned prism sheet.

### SUMMARY

In one embodiment, a prism sheet includes a lower surface, an upper surface and a refractive-diffractive hybrid lens array. The upper surface is opposite to the lower surface. The refractive-diffractive hybrid lens array is formed on the upper surface and includes a plurality of refractive-diffractive hybrid lenses. Each refractive-diffractive hybrid lens is, advantageously, a homocentric (i.e., concentric), stepped cylindrical dot.

In another embodiment, a backlight module includes the above-described prism sheet, a light guide plate, a light source, a reflective cover, a reflector, and a diffusion plate. The light guide plate includes an incidence surface, an emission surface, and a bottom surface. The emission surface intersects with the incidence surface. The bottom surface intersects with the incidence surface and is opposite to the emission surface. The light source is partially/selectively covered by the reflective cover and is positioned beside the incidence surface of the light guide plate. The reflector is located below the bottom surface of the light guide plate. The diffusion plate is placed upon the emission surface of the light guide plate. The prism sheet is situated upon the diffusion plate.

In use, light beams emitted from the light source are transmitted to the incidence surface of the light guide plate and are emitted from the emission surface of the light guide plate. The reflector is used to reflect some (preferably most) of the incident light beams that are emitted from the bottom surface of the light guide plate back into the light guide plate. Then, the emitted light beams are transmitted through the diffusion plate and are further transmitted through the prism sheet via the refractive-diffractive hybrid lenses.

Compared with a conventional prism sheet, the refractive-diffractive hybrid lenses of the present prism sheet can reduce or even avoid chromatic aberration along axes thereof. Such lenses can converge the emitted light beams, thereby enhancing uniformity of the light beams emitted from the present prism sheet. Furthermore, the refractive-diffractive hybrid lens array and the body of the prism sheet are integrally co-formed by means of injection molding. This molding procedure ensures relatively little processing of the prism sheet in the production line. Thus, the present prism sheet is easy to make, thereby saving cost. Therefore, the present backlight module, adopting the present prism sheet, can provide satisfactory display quality and can be advantageously applied in liquid crystal display devices.

Other advantages and novel features of the present prism sheet and the backlight module adopting the same will become more apparent from the following detailed description of preferred embodiments when taken in conjunction with the accompanying drawings.

### BRIEF DESCRIPTION OF THE DRAWINGS

Many aspects of the present prism sheet and the related backlight module can be better understood with reference to the following drawings. The components in the drawings are not necessarily to scale, the emphasis instead being placed upon clearly illustrating the principles of the present prism sheet and the related backlight module.

FIG. 1 is an isometric view of a prism sheet in accordance with a preferred embodiment of the present device;

FIG. 2 is a schematic, partly enlarged cross-sectional view of the prism sheet of FIG. 1;

FIG. 3 is a schematic, side view of a backlight module in accordance with a preferred embodiment of the present device, showing the backlight module adopting the prism sheet of FIG. 1; and

FIG. 4 is a schematic, side view of a conventional backlight module.

Corresponding reference characters indicate corresponding parts throughout the several views. The exemplifications set out herein illustrate at least one preferred embodiment of the present prism sheet and the related backlight module, in one form, and such exemplifications are not to be construed as limiting the scope of the invention in any manner.

### DETAILED DESCRIPTION OF PREFERRED EMBODIMENTS

Reference will now be made to the drawings to describe embodiments of the present prism sheet and the related backlight module, in detail.

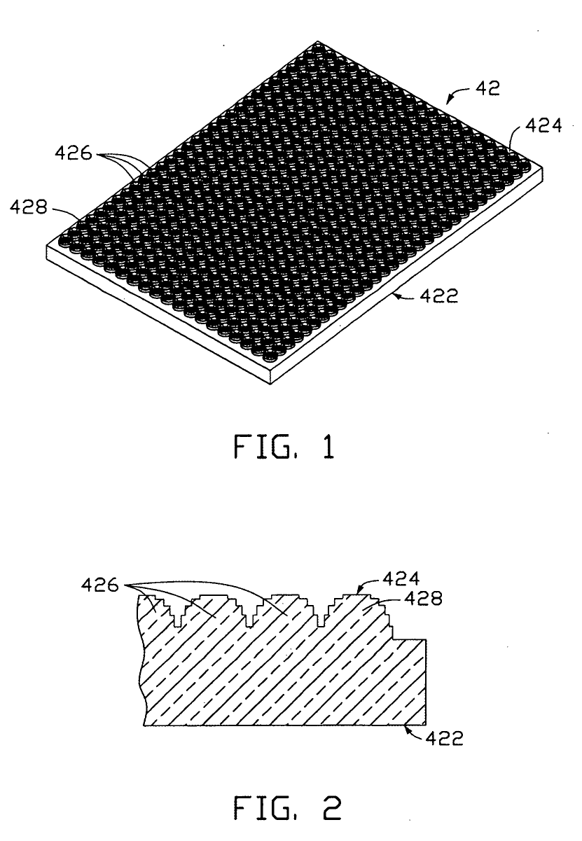

Referring to FIG. 1, a prism sheet 42 includes a lower surface 422, an upper surface 424, and a refractive-diffractive hybrid lens array 426. The upper surface 424 is opposite to the lower surface 422. The refractive-diffractive hybrid lens array 426 is formed on the upper surface 424 and includes a plurality of refractive-diffractive hybrid lenses 428. The refractive-diffractive hybrid lenses 428 are, beneficially, arranged in multiple rows and multiple columns. The prism sheet 42 is advantageously made of an organic resin having high refractive index, good transparency, and satisfactory light transmissivity. The organic resin can be, for example, a polyester, a polycarbonate, or polymethyl methacrylate (PMMA), and so on. Such a resin not only provides the proper optical properties but also is readily injection-molded.

A structure of the refractive-diffractive hybrid lens array 426 can be formed in an original mold for the prism sheet 42. Such a mold can be formed by means of electronic beam machining, laser machining, or electron beam lithography (EBL) and can be made of any of various known mold materials. Thus, the refractive-diffractive hybrid lens array 426 and the body of the prism sheet 42 can be co-formed by means of injection molding. This molding process ensures that relatively little manufacturing processing is devoted to generating the prism sheet 42 in the production line. Thus, the present prism sheet 42 is easily made, thereby saving cost.

FIG. 2 is a schematic, partly enlarged cross-sectional view of the prism sheet 42 of FIG. 1. As shown in FIG. 2, each refractive-diffractive hybrid lens 428 is, advantageously, a homocentric, stepped cylindrical dot and is a combination of a refractive lens and a diffractive lens. It is, however, to be understood that any hybrid lens configuration that would provide both refractive and diffractive lens qualities and that could be readily formed (e.g., molded) would be considered to be within the scope of the present prism sheet.

With refractive lenses, lights with relatively long wavelengths have relatively small refraction angles and are focused at relatively far points when they travel through refractive lenses, while lights with relatively short wavelengths have relatively big refraction angles and are focused at relatively near points when they travel through the refractive lenses. That is to say, the focus of each blue light, the focus of each green light and the focus of each red light are sequentially located on an axis of the corresponding refractive lens. This variance in focus by refractive lenses results in chromatic aberration. Conversely, with diffractive lenses, the lights with the relatively long wavelengths have relatively big diffraction angles and are focused at relatively near points when they travel through diffractive lenses, while the lights with the relatively short wavelengths have relatively small diffraction angles and are focused at relatively far points when they travel through the diffractive lenses. That is to say, the focus of each red light, the focus of each green light, and the focus of each blue light are sequentially located on an axis of the corresponding diffractive lens. This variance in focus by diffractive lenses results in inverse chromatic aberration.

Therefore, when the light beams including relatively long-wavelength light and relatively short-wavelength light are transmitted through the refractive-diffractive hybrid lens 428, which is a combination of a refractive lens and a diffractive lens, the above-described two kinds of chromatic aberration can be counteracted. This counteraction can effectively converge the light beams, thereby enhancing the uniformity of the light beams. The convergence effect can be controlled by adjusting the step number of each refractive-diffractive hybrid lens 428.

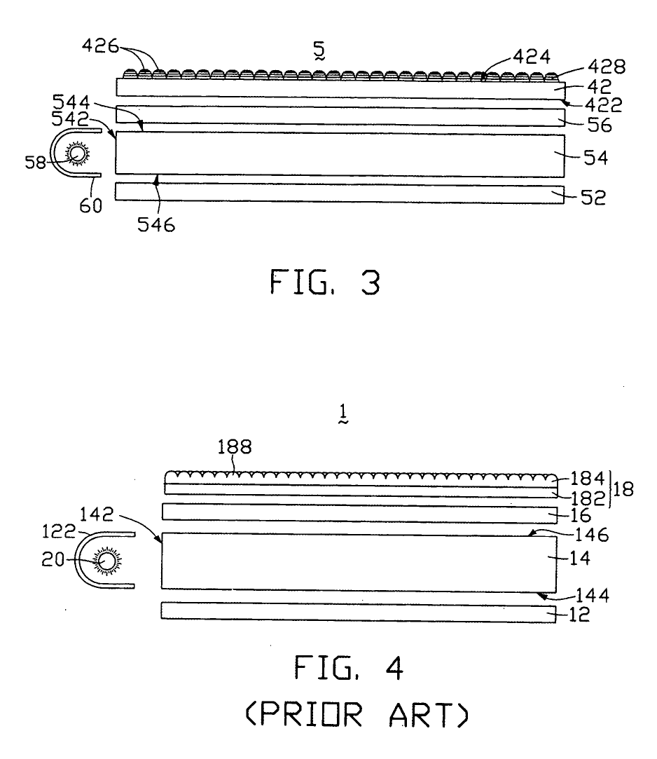

Referring to FIG. 3, a backlight module 5 in accordance with another preferred embodiment of the present device is shown. The backlight module 5 adopts the above-described prism sheet 42 and further includes a light guide plate 54, a light source 58, a reflective cover 60, a reflector 52, and a diffusion plate 56. The light guide plate 54 includes an incidence surface 542, an emission surface 544, and a bottom surface 546. The emission surface 544 intersects with the incidence surface 542. The bottom surface 546 intersects with the incidence surface 542 and is opposite to the emission surface 544. The light source 58 is selectively covered by the cover 60 to reflect misdirected light, and the light source 58 is positioned beside the incidence surface 542 of the light guide plate 54. The reflector 52 is located below the bottom surface 546 of the light guide plate 54. The diffusion plate 56 is placed upon the emission surface 544 of the light guide plate 54. The prism sheet 42 is situated upon the diffusion plate 56.

In use, incident light beams are emitted from the light source 58 and are transmitted into the light guide plate 54 via the incidence surface 542. The light guide plate 54 directs travel of the incident light beams therein and ensures that most of the incident light beams can be emitted from the emission surface 544 thereof The reflector 52 is used to reflect some (preferably, most) of the incident light beams that are emitted from the bottom surface 546 of the light guide plate 54 back into the light guide plate 54. This reflection enhances the utilization ratio of the incident light beams. Then, the emitted light beams are transmitted through the diffusion plate 56 and the prism sheet 42 via the refractive-diffractive hybrid lenses 428. The emitted light beams are thereby converged by the refractive-diffractive hybrid lenses 428. This convergence enhances the uniformity of the emitted light beams. Therefore, the present backlight module 5, adopting the present prism sheet 42, has a satisfactory display quality and can be advantageously applied in liquid crystal display devices.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A prism sheet comprising:
a first surface;
a second surface opposite to the first surface; and
a plurality of refractive-diffractive hybrid lenses formed on the second surface.

2. The prism sheet as claimed in claim 1, wherein the refractive-diffractive hybrid lenses are formed on the second surface in multiple rows and multiple columns.

3. The prism sheet as claimed in claim 1, wherein each refractive-diffractive hybrid lens is a combination of a refractive lens and a diffractive lens.

4. The prism sheet as claimed in claim 1, wherein each refractive-diffractive hybrid lens is a homocentric, stepped cylindrical dot.

5. The prism sheet as claimed in claim 1, wherein the prism sheet, including the refractive-diffractive hybrid lenses, is formed by a molding process, the prism sheet thereby being an integral unit.

6. The prism sheet as claimed in claim 1, wherein the prism sheet is made of an organic resin having a high refractive index, good transparency, and satisfactory light transmissivity.

7. The prism sheet as claimed in claim 6, wherein the organic resin is a polyester.

8. The prism sheet as claimed in claim 6, wherein the organic resin is a polycarbonate.

9. The prism sheet as claimed in claim 6, wherein the organic resin is polymethyl methacrylate.

10. A backlight module comprising:
a light guide plate;
at least a light source positioned beside the light guide plate; and
a prism sheet located upon the light guide plate and comprising:
a lower surface directed toward the light guide plate;
an upper surface opposite to the lower surface; and
a plurality of refractive-diffractive hybrid lenses formed on the upper surface.

11. The backlight module as claimed in claim 10, further comprises a diffusion plate placed between the prism sheet and the light guide plate.

12. The backlight module as claimed in claim 10, wherein the refractive-diffractive hybrid lenses are arranged in multiple rows and multiple columns on the upper surface of the prism sheet.

13. The backlight module as claimed in claim 10, wherein each refractive-diffractive hybrid lens is a combination of a refractive lens and a diffractive lens.

14. The backlight module as claimed in claim 10, wherein each refractive-diffractive hybrid lens is a homocentric stepped cylindrical dot.

15. The backlight module as claimed in claim 10, wherein the prism sheet, including the refractive-diffractive hybrid lenses, is formed by a molding process, the prism sheet thereby being an integral unit.

16. The backlight module as claimed in claim 10, wherein the prism sheet is made of an organic resin having a high refractive index, good transparency, and satisfactory light transmissivity.
